(19) United States
(12) Patent Application Publication
(10) Pub. No.: US 2004/0241297 A1
(43) Pub. Date: Dec. 2, 2004

(54) Device for production and application of whipped cream

(76) Inventor: Robert Fricker, Kussnacht (CH)

Correspondence Address: WENDEROTH, LIND & PONACK, L.L.P., 2033 K STREET N. W., SUITE 800, WASHINGTON, DC, 20006-1021, US

(21) Appl. No.: 10/492,684

(22) PCT Filed: Sep. 30, 2002
(86) PCT No.: PCT/EP02/10956

(30) Foreign Application Priority Data
Oct. 17, 2001 (CH) 2001-1906/01

(51) Int. Cl. A23B 4/00

(52) U.S. Cl. 426/409

(57) ABSTRACT

A device (10), for production and application of whipped cream, comprises a cream container (15) arranged therein, from which liquid cream may be supplied through a line (18), using a means (11), to an outlet nozzle (101) of an outlet head (100). A tube (25), connected at one end to the outlet head (110) is arranged such as to be drawn in or out, to or from, said device (10), whereby if required the outlet head (40) is fixed to the device (10) or detachable therefrom. The tube (25) and a part of the outlet head (100) provided for the passage of cream and thus the cream remaining therein are cooled in the drawn-in state of the tube (25). The device (10) permits the user an optimal operation, when, after the expression of cream, the tube (25) independently withdraws into the device (10).

The invention relates to a device for the production and application of whipped cream in accordance with the preamble to claim 1.

With a known machine for the whipping of foam masses, in particular whipped cream, according to DE-C1 35 21 982, a refrigerating machine driven by a compressor is arranged in a housing, by means of which the space formed by the housing is cooled, into which a cream container accommodating the liquid cream can be introduced. In this situation, a riser pipe line projects into said container, which leads to the device head of the machine, which contains the device for whipping the liquid cream and is connected to an outlet pipe running vertically downwards.

With this known machine, the liquid cream located in the container is sucked out by a pump through the riser pipe line and pressed through the device, consisting of several resistance pipes, together with the air which is likewise sucked in. As a result, the liquid cream is processed to form whipped cream and can then be discharged in a metered manner through the outlet pipe located in the device head by means of an actuating clement, for example by pressing a button. A disadvantage in this situation for a user is that it is essential, when removing the cream, for a plate, a cup, or the like to be placed beneath this outlet pipe secured to the front face of the machine.

There are already devices known in which the outlet pipe can be connected by means of a connection hose to the device head. As a result, this outlet pipe can be removed to a certain distance from the device and the whipped cream can consequently be discharged onto a plate, a cup, or the like without the plate needing to be placed directly in front of the device. When such a device is not in use, however, whipped cream which is not cooled remains in the hose, and therefore relatively rapidly becomes unpalatable. When the next discharge takes place, it is possible that this cream which has remained for a while in the hose can no longer be used and must therefore be disposed of.

Taking this known device as; a starting point, the present invention is based on the problem of further developing a device of this generic type in such a way that with this device extremely user-friendly and simple handling is guaranteed at the discharge of the whipped cream, and that, in addition, when the device is not in use no unpalatable stagnant cream remains in the connection hose.

According to the invention, the problem is resolved by a device with the features of claim 1.

This device according to the invention allows a user an optimum means of working, since, after the discharge of the whipped cream, the hose,. together with the part of the outlet head conveying the cream withdraws back into the device and does not lie in an inconvenient manner in the area in front of the device serving as a workplace. In tis drawn-in state both the hose and the part of the outlet head proposed for the discharge of the cream, and the cream remaining therein, are cooled. The cream is therefore always in a fresh and palatable state, and the formation of bacteria in the device can largely be prevented.

A further advantage lies in the fact that, when the outlet head is inserted into an opening in the housing, the cooling chamber formed therein is closed,

The invention and further advantages thereof are explained in greater detail hereinafter on the basis of the drawings. These show:

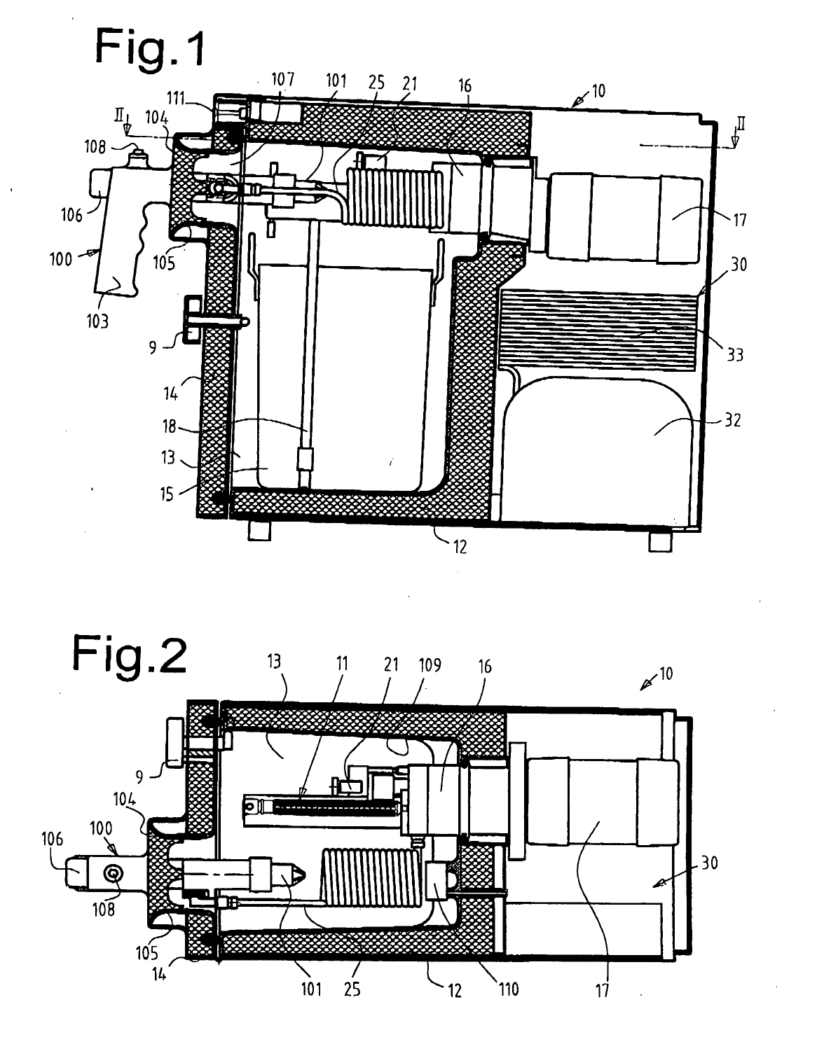

FIG. 1 A diagrammatic representation of a first embodiment of a device according to the invention, in a longitudinal section:

FIG. 2 A section according to the line II-II in FIG. 1;

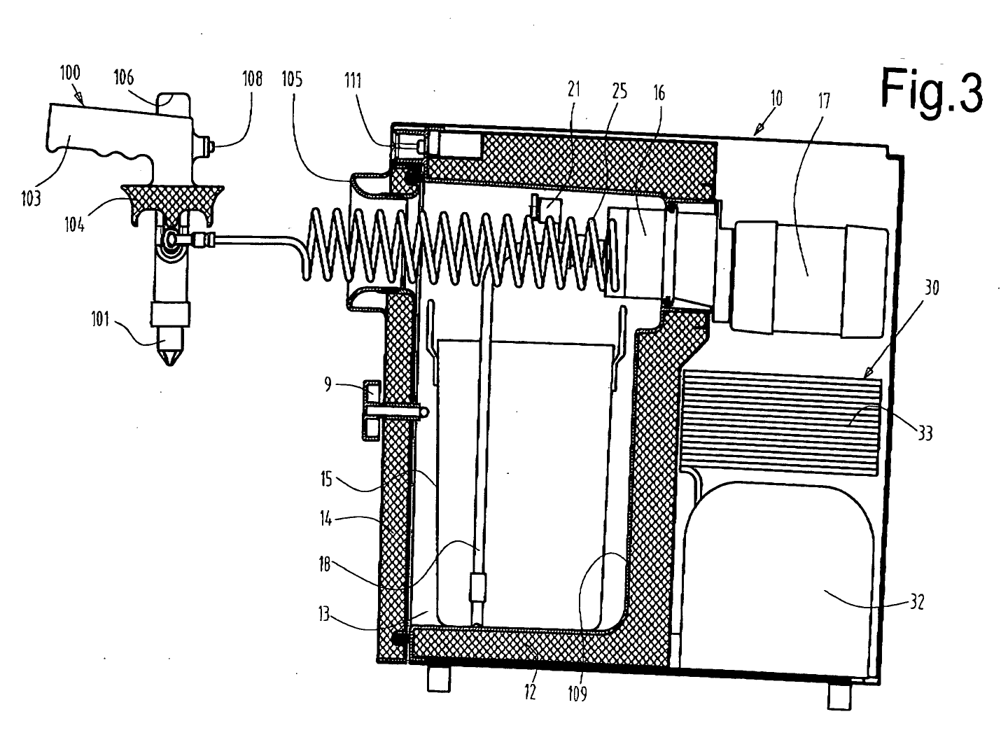

FIG. 3 A representation of the device in a position for use, corresponding to FIG. 1;

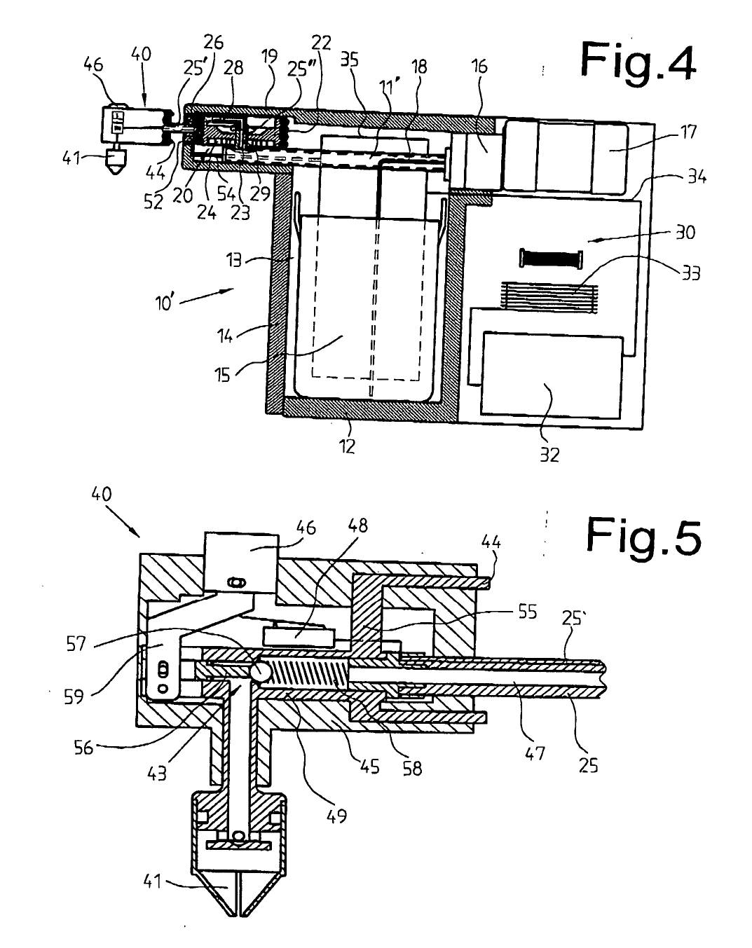

FIG. 4 A diagrammatic representation of a second embodiment of a device according to the invention, in a longitudinal section;

FIG. 5 A partial longitudinal section rough an outlet bead of the device according to FIG. 4; and

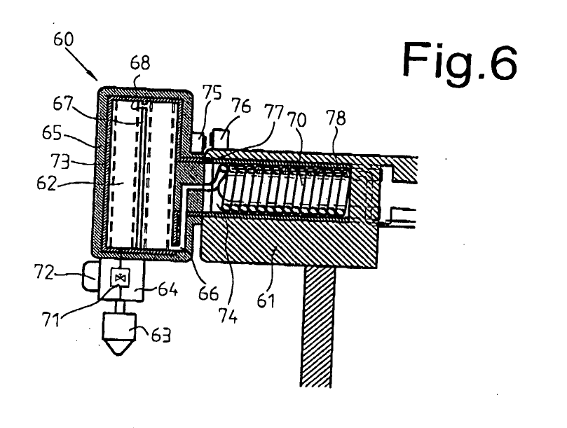

FIG. 6 A partial longitudinal section through an outlet head and the front face of an alternative device.

FIG. 1 shows a diagrammatic representation of a device 10 for the production and application of whipped cream, which exhibits a housing 12. Located in the rear area of the device 10 is a cooling device 30 and an electric motor 17 arranged above this as a drive element for a pump 16 conveying the cream. Formed in the front part of the device 10 is a closed cooling chamber 13, for preference thermally insulated, arranged in which is a cream container 15 which accommodates the liquid cream, and in which, in a particularly advantageous manner, the pump 16 is also located. The cream container 15 can be removed from this cooling chamber 13 or inserted into it by means of a pivotable cover 14 arranged on the front face of the device 10. In this situation attention is to be paid to the fact that a suction line 18 for the cream, connected to the pump 16 on the inlet side, is laid into the interior of the cream container 15. The door 14 is arranged such that in the closed position it can be locked by means of a locking element 9.

Additionally located in the cooling chamber 13 are means 11 (sec FIG. 2) connected to the pump 16, which, as a resistance passage element, are inherently known in design and function and arc therefore not described in any detail. Said means are basically shaped as a longitudinal cylinder, and form a ring-shaped labyrinth passage running along a longitudinal axis, through which the liquid cream and air are pressed by means, for example, of a pump provided as a gear pump 16, and the cream is therefore whipped.

With the embodiment represented in FIGS. 1 to 3, the resistance passage element 1, which for the successful production of the whipped cream must exhibit a specific minimum length, is subdivided in a particularly advantageous manner into two sections arranged above one another and following one another in the circuit, with the result that its overall length can be kept short, which has a positive effect on the size of the housing 12 and, for example, also allows for the trouble-free accommodation of the pump 16 in the cooling chamber 13. Air is conducted to the upper section of the resistance passage clement 11 which is directed forwards from the pump 16 towards the front face of the device 10 via an air valve 21. The lower section of the resistance passage element 11, which is connected to the upper section in the front area, is connected in its rear area to a hose 25, which is connected at its other outlet-side end to an outlet head 100, from the outlet nozzle 101 of which (see in particular FIG. 3) the whipped cream can be drawn off by pressing a button, as is described hereinafter in greater detail in the embodiment example of an outlet head 40 represented in FIG. 5. The corresponding pushbutton is designated in FIGS. 1 and 3 by 106; in addition, a further pushbutton 108 is provided for a continuous outlet.

The outlet head 100 can be held on the device, as required, by means of the hose 25, formed as a helical tensile spring, capable of being drawn into and out of the device 10, or can be removed from this to a certain distance (for both positions see FIGS. 1 and 3). For this purpose the outlet head 100 is provided with a handle 103 as well as with a ring-shaped flange 104, concentric to the outlet nozzle 101, whereby, when the outlet head 100 is not in use, said flange is inserted into an aperture 107 with an insertion sleeve 105 in the front face of the housing 12 or in the door 14 (FIG. 1) and closes off the cooling chamber 13 with a scaling effect. The handle 103 is angled in relation to the axis of the outlet nozzle 101, as a result of which the outlet head 100 exhibits a pistol shape. The hose 25 is connected in a jointed manner to the outlet head 100, so that the outlet head 101 is taken out of the insertion sleeve 105 by means of the handle 103, and can be pivoted, for example, into the position shown in FIG. 3, in which the outlet nozzle 101 is directed downwards, in order for the whipped cream to fill a cup or plate located or connected beneath it.

After use the outlet head 100 with the flange 104 can be inserted back into the insertion sleeve 105, whereby the hose 25 retracts automatically. In this drawn-in state both the hose 25 as well as the pipe wall of the outlet head 100, forming the passage aperture for the cream to pass through and ending in the outlet nozzle 101, are located entirely in the cooling chamber 13 and arm therefore cooled together with the whipped cream remaining in them. Because the pump 16 is also located in the cooling chamber 13, all, the parts through which the cream is conducted are kept cooled in a particularly simple manner.

The opening 107 provided with the insertion sleeve 105, for the outlet head 100, and the hose 25 respectively are allocated to advantage to the topmost area of the cooling chamber 13, in order for the heat losses in the cooling chamber 13 to be kept as small as possible when the outlet head 100 is drawn out.

The refrigerating device 30 Judy mentioned for cooling the cooling chamber 13 is inherently known and essentially comprises a compressor 32 as well as a heat exchanger 33, which is connected for the purpose of effect to refrigerating walls of the cooling chamber 13 in a manner not represented in any greater detail. These walls can be arranged, for example, inside the cooling chamber 13, are U-shaped in a plan view, and are protected by protective shell elements 109 made of plastic and open to the front (FIG. 2). The temperature in the cooling chamber is set for preference at 4° C.

To improve the air circulation, a fan 110 (FIG. 2) is located to advantage in the cooling chamber 13.

Arranged on the front face of the device 10, for preference in the upper area, is a main switch 111 for switching the device 10 on and off, with a display.

FIG. 4 shows a further variant of a device 10′, for the production and application of whipped cream, represented in diagrammatic form, at the device head 19 of which an outlet head 40 is provided for, which exhibits an outlet nozzle 41 directed approximately downwards, from which in turn the whipped cream can be removed by the actuation of a pushbutton 46. The parts of the device 10′ which remain essentially the same in their function are designated in FIG. 4 with the same reference numbers as in FIGS. 1 to 3.

The outlet head 40 is in turn connected by a hose 25′ to a resistance passage element 11′, which is designed as a longitudinal cylinder connected to the pump 16 and projecting into the front device head 19. Located in the device bead 19 is a device 20 which accommodates the hose 25′, which comprises a roll 22, a helical spring 24 interacting with this, a sleeve 23 which carries the roll 22 in a rotatable manner, and a line piece 28 connected to said sleeve at right angles. This line piece 28 together with the sleeve 23 forms a passage apt, through which this whipped cream is conducted into the hose 25′ at the outlet of the resistance passage element 11′, said hose being wound around the roll 22 in the state as represented, extending trough a scraping ring 26 arranged in the device bead 19 and secured in the outlet bead 40, whereby this scraping ring 26 prevents any dirt which may be on the hose from penetrating the housing 12, and additionally serves as a seal for avoiding the emanation of cold from the refrigerated interior of the housing 12. The helical spring 24 arranged on the front face at the roll 22 is secured at one end to the roll 22 and at the other end to the fixed sleeve 23. When the hose 25′ unwound from the roll 22 is drawn out, the rotation of the roll 22 which is then caused incurs a tensioning of the helical spring 24, as a result of which a force is transferred to the hose 25′, by means of which this is automatically drawn back. Via spring force is to be dimensioned in such a way that the hose 25′ will be reliably drawn back but that the outlet head 40 secured to the end of the hose is not drawn back by this spring 24 in the extracted state if it is released by the user. In addition to this, the interior of the device head 19, which accommodates the device 20, said device head projecting opposite the housing 12, forms a part of the cooling chamber 13, whereby it is guaranteed that the hose 25′ together with the whipped cream remaining in it is cooled when in the drawn-in state.

The cooling device 30, arranged in tun on the rear of the device 10′, comprises a line 34 leading into the cooling chamber 13 with a runback, as well as a choke valve, not shown, by means of which a line coil 35 located in the cooling chamber 13 is cooled in such a way that the temperature in the cooling chamber is set for preference at 4° C. This line coil 35 is, as indicated, located in the cooling chamber 13 in a known manner in such a way that it exerts an optimum transfer of cold to the air in the cooling chamber.

The outlet head 40 can be secured in a releasable manner by means of plugs 44 in a corresponding adapter 52 of the device head 19. The adapter 52 is connected to a cold connection line 54, fed by the refrigerating device 30, and in the inserted state of the outlet head 40 forms a cold bridge which has the effect of transferring the cold to the plug 44.

In addition to this, an electric cable 23″ is embedded in the hose 25′, which in the wound up state of the hose 25′ is wound a few times around the sleeve 23 and is guided as far as a switch, not shown, which switches the electric motor 17 on and off.

With a device according to the invention, the outlet head 40 can be taken by a laser in his hand, positioned over a plate or cup, a certain quantity of whipped cream can be let out by actuating the pushbutton 46, and the head then pushed back into the device head 19, whereby the hose 25′ withdraws automatically into the interior of the housing during the last procedure.

The outlet head 40 shown in longitudinal section in FIG. 5 ha., a closed housing 45, through which a pipe wall 49 is conducted, which ends in the outlet nozzle 41 and forms a throughfow aperture 47, which can be closed off by a valve 43. The valve 43 exhibits a ball element 57, which closes the passage aperture 47, a pressure spring 58 taking effect on this ball element in the closed position, and a bolt 56 which pushes the ball element 57 into the opening direction, this bolt being connected in jointed fashion by Scans of a mechanical connecting part 59 to the pushbutton 46. When the pushbutton 46 is actuated, first a microswitch 48 is switched on, which is connected via the electric cable 25″ to the switch which sets the electric motor 17 in operation. The cream is then pressed by means of the pump 16, which is likewise switched on, through the resistance passage element 11′ and whipped as a result, through the valve 43 opened by the pushbutton 46, and then let out through the outlet nozzle 41. As soon as the pushbutton 46 is released again, the electric motor 17 stops and the valve 43 is moved into the closed position again.

The cold energy transferred by the adapter 52 onto the plugs 44 is conducted further via a connecting part 55 provided in the housing 45 of the outlet head 40 onto the pipe wall 49. Said pipe wall extends from the hose 25′, which ends in the housing 45 and is secured therein, as far as the outlet nozzle 41, with which, after the removal of cream and after the insertion explained heretofore, the cream remaining in the outlet head 40 is cooled. At the subsequent outlet of cream, this is palatable as before, and can therefore be used without any problem. The plug 44, the connecting part 55, and the pipe wall 49 are for this purpose made of a cold-conductive material, such as a metal, while the housing 45 surrounding this is manufactured from a cold-insulating material, such as plastic, or at least the pipe wall 49 is sheathed with such a material. The housing 45 of the outlet head 40 is designed on its outer circumference to the purpose in such a way that it can be readily taken up by hand.

FIG. 6 shows another design of outlet head 60, which is pushed onto a device head 61 of a device not represented here in any greater detail, This is essentially a device which corresponds to the device 10′ according to FIG. 4, but which differs from this in particular in that a resistance passage element 62 is integrated directly in the outlet head 60. This provides the advantage that the cream is not whipped until before being let out at the outlet nozzle 63, and therefore better preservation time can be achieved, The resistance passage element 62 is in this situation arranged in two parts in a housing 65 of the outlet head 60, and the cream is conducted out from the bole 66 formed in the housing 65 through the first part and, after passing through a hole 68 in an intermediate wall 67, is conducted through the second part of the resistance passage element 62. In the whipped state, the mm is then conveyed into the outlet head 63, with the valve 71 in a switch part 64, shown in the open state, and actuated by the button 72. The plug connection 77 in turn allows a cold bridge to be formed, by means of which the outlet head 60 is cooled, by way of the cold-conducting cladding 73 provided on the inner side of its housing 65.

According to the invention, this outlet head 60 can in turn be removed from the device head 61, and for this purpose a hose 70 is secured to it, in the form of a helical tension spring, which in the drawn-in state shown is placed in a cooled recess 74 formed on the device head 61. This recess 74 is in this situation surrounded by a cooling ring 78, which is connected to a cooling line of the cooling device. When the outlet head 60 is removed, this hose is taken with it, in that, when the outlet head 60 is retracted, the hose 70 automatically draws back into this recess 74. The hose 70 is additionally connected in the interior of the device housing directly to the pump which conveys the cream.

In addition, this outlet head 60 is equipped with an infra-red transmitter 75 or the like for the purpose of switching on and off the electric motor which operates the pump, said transmitter sending a signal to the receiver part 76 when the button 72 is actuated, and said receiver part in turn switching a switch of the electric motor on and off. Instead of an infra-red transmitter, provision can of course be made for another cableless type of signal transfer.

With the device 10 according to FIGS. 1 to 3, the signal transfer can be effected from the outlet head 100 to the electric motor 17, which switches the pump 16 on and off, via an electric cable or without a cable.

Naturally the invention can also be represented in other variants. The embodiment examples represented heretofore are, however, adequate to provide a comprehensive explanation of the invention.

It should further be mentioned in this context that the signal transfer explained heretofore from, the outlet head to the switch of the electric motor could also be effected in another way, and specifically in that a pressure sensor would be installed at the output of the resistance passage element, which would cause the motor and therefore the pump to be switched on and off when the pressure measured by the pressure sensor falls below a specific reference level or rises above a specified reference level.

The outlet head 100 according to FIG. 1 is designed in its interior as the same as that according to FIG. 5. A representation of this has therefore been waived. The part of the outlet head provided for the passage of cream consists of the pipe wall 49 and the outlet nozzle 41, through which the cream flows.

The invention is adequately represented by the embodiment examples explained heretofore. The means for the production of the cream, which is realised by a resistance passage element, could also be designed in another manner.

1-13. (Cancelled).

14. Device for production and application of whipped cream with a cream container (15) arranged therein, from which liquid cream can be conveyed via a line through means (11; 11′; 62) for the production of whipped cream and then through an outlet nozzle (101; 41; 63) of an outlet head (100; 40; 60), whereby at said outlet head a hose (25; 25′; 70) is secured which is connected to the device (10; 10′), said hose being connected to the line conveying the cream, wherein the hose (25; 25′; 70), connected at one end to the outlet head (100; 40; 60) is arranged in this device (10; 10′) in such a way as to be drawn in and drawn out, as a result of which the outlet head (100; 40; 60) is, as required, held to the device (10; 10′) or can be removed from it, and that this hose (25; 25′; 70), as well as a part of the outlet head (100; 40; 60) provided for the passage of the cream, are kept cool in the drawn-in state of the hose (25; 25′; 70).

15. Device according to claim 14, wherein the hose (25; 25′; 70) can be automatically drawn back into a cooling chamber (13; 74) of the device (10; 10′) and is cooled therein in the drawn-in state.

16. Device according to claim 15, wherein the hose (25; 25′; 70) is designed as a helical tension spring.

17. Device according to claim 16, wherein the outlet head (100) is connected to the hose (25) in jointed fashion, in the drawn-out state can be pivoted into a working position and when drawn in is pivoted back and can be inserted into an opening (107) of the device (10), provided with an insertion sleeve (105) and opening into the cooling chamber (13), whereby the part of the outlet head (100) provided for the passage of the cream is located in the drawn-in state in the cooling chamber (13).

18. Device according to claim 17, wherein the outlet head (100) is provided with a handle (103) angled to the outlet nozzle (101) and formed in the manner of a pistol handle, as well as with a flange (104) which closes off in scaling manner an aperture (107) opening into the cooling chamber (13) in the drawn-in state, so that the cooling chamber (13; 74) is closed when the outlet head (100) is pushed on.

19. Device according to claim 17, wherein the aperture (107) provided with the sleeve (105) opens into the upper area of the cooling chamber (13), in which are arranged the cream container (15), the line (18) conveying the cream, the means (11) for the production of the cream, and the pump (16).

20. Device according to claim 19, wherein the means (11) are formed from a resistance passage element and are subdivided into two sections arranged parallel to one another but connected after one another in the circuit.

21. Device according to claim 14, wherein the outlet head (40; 60) in the drawn-in state forms a cold bridge with a cold connection line (54) of a cooling device (30), arranged in the device (10′) in the drawn-in state, by means of which at least the pipe wall (49) is cooled which forms the throughflow aperture for the crown flow.

22. Device according to claim 21, wherein the outlet head (40; 60) can be secured to an adapter (52) on the device head (19) by means of plugs located on it, whereby the adapter (52) is connected to the cold connection line (54), as a result of which, with the outlet head (40; 60) in the plugged-in state, a transfer of the cold to the plugs (44) is exerted, and, as a result, via a connection part (55), onto the pipe wall (49).

23. Device according to 14, wherein the hose (25′) can be retracted automatically into the cooling chamber (13) by a device (20) provided in the cooling chamber, which comprises the roll (22) arranged in the device head (19), a sleeve (23) mounted in rotatable fashion on said roll, a helical spring (24) interacting with the roll (22), and a line piece (28), which connects the end of the hose (25′) located opposite the outlet head (40) to the means (11) mounted in the device (10′).

24. Device according to claim 14, wherein a pushbutton (106; 46; 72) is located at the outlet head (100; 40; 60), by the actuation of which a pump (16) which conveys the liquid cream is switched on and off, and, on the other hand, a valve (43) arranged in the outlet bead (100; 40; 60) is opened or closed respectively.

25. Device according to claim 24, wherein the pushbutton (46) in the outlet head (40) actuates a microswitch (48), which is connected to a switch for switching on and off an electric motor (17) driving the pump (16) via an electric cable (25′) integrated in the hose (25) or by means of cableless signal transfer, such as by means of an infra-red transmitter (75, 76).

26. Device according to claim 14, wherein the means (62) are integrated directly in the outlet head (60).

27. Device according to claim 18, wherein the aperture (107) provided with the sleeve (105) opens into the upper area of the cooling chamber (13), in which are arranged the cream container (15), the line (18) conveying the cream, the means (11) for the production of the cream, and the pump (16).

28. Device according to claim 15, wherein the outlet head (40; 60) in the drawn-in state forms a cold bridge with a cold connection line (54) of a cooling device (30), arranged in the device (10′) in the drawn-in state, by means of which at least the pipe wall (49) is cooled which forms the throughflow aperture for the crown flow.

29. Device according to 15, wherein the hose (25′) can be retracted automatically into the cooling chamber (13) by a device (20) provided in the cooling chamber, which comprises the roll (22) arranged in the device head (19), a sleeve (23) mounted in rotatable fashion on said roll, a helical spring (24) interacting with the roll (22), and a line piece (28), which connects the end of the hose (25′) located opposite the outlet head (40) to the means (11) mounted in the device (10′).

30. Device according to claim 15, wherein the means (62) are integrated directly in the outlet head (60).

31. Device according to claim 16, wherein the means (62) are integrated directly in the outlet head (60).

32. Device according to claim 17, wherein the means (62) are integrated directly in the outlet head (60).

33. Device according to claim 18, wherein the means (62) are integrated directly in the outlet head (60).
